(19) United States
(12) Patent Application Publication
(10) Pub. No.: US 2010/0138020 A1
(43) Pub. Date: Jun. 3, 2010

(54) CROWNING PROFILE

(75) Inventor: Magnus Gustafsson, Torslanda (SE)

Correspondence Address: WRB-IP LLP, 1217 KING STREET, ALEXANDRIA, VA, 22314, US

(73) Assignee: VOLVO LASTVAGNAR AB, Göteborg (SE)

(21) Appl. No.: 12/092,592

(22) PCT Filed: Nov. 3, 2005
(86) PCT No.: PCT/SE05/01653

§ 371 Date: Jun. 16, 2008

(51) Int. Cl. G06F 17/50; F16H 53/00; G06F 17/10

(52) U.S. Cl. 700/98; 74/567; 703/1; 703/2

(57) ABSTRACT

A contact element that is arranged to follow, i.e. slide or roll, against a mating part includes a contact surface having a crowning profile on at least a part thereof. The crowning profile is defined by the function Y(X)=AX6 where Y is the crowning quantity, X is the distance from the centre of the contact surface of the contact element, A and B are real numbers and B is greater than 2.

### BACKGROUND AND SUMMARY

The present invention concerns a contact element that is arranged to be rotatably mounted and to abut against a mating part, said contact element comprising an at least partly crowned contact surface. “Rotatably mounted” is intended to mean than the contact element is able turn through at least part of one revolution about an axis and thus includes contact elements that are pivotably mounted.

Contact elements that are arranged to be rotatably or pivotably mounted and to abut against mating parts so as to come into rolling or sliding contact with the mating parts are sometimes provided with a crowned contact surface. The crowned contact surface distributes pressure uniformly over the contact surface and prevents excessively high contact pressure from being generated at the ends of a contact surface. Increased contact pressure on a contact surface accelerates the wear, scuffing and exfoliation of the contact surface. This can result in unstable rotation and skidding of a contact element across its mating part, which consequently decreases the working lifetime of both the contact element and the mating part and adversely affects the performance and reliability of any system containing said components.

Crowning also compensates for minor misalignment of a contact element with its mating part thereby suppressing increases in contact pressure resulting from non-parallel contact. However, if said misalignment is too large, due to manufacturing and/or assembling imperfections, the advantages of using a crowned contact surface are reduced or eliminated.

Both spherical and logarithmic crowning profiles are known. Contact elements comprising a spherical crowning profile contact a mating part at a point, which greatly reduces friction between said components but if such a contact element is overloaded, i.e. if the contact pressure at the contact point is too high, the contact element can deform and be ruined. Such a problem is alleviated using a logarithmic crowning profile, such as the one disclosed in U.S. Pat. No. 6,390,685, since a logarithmic crowning profile increases the contact area between a contact element and a mating part compared to a spherical crowning profile and consequently decreases the contact pressure on the contact element for a given contact force. Contact elements having a logarithmic crowning profile are however difficult to fabricate.

It is desirable to provide a contact element that is arranged to follow, i.e. slide or roll, against a mating part and that comprises a contact surface having a crowning profile on at least a part thereof, i.e. at least part, if not the whole of the contact surface has a crowning profile, which helps to extend the working lifetime of the contact element and the mating part.

According to an aspect of the present invention, a contact element having a crowning profile defined by the function Y(X)=AX^{B} where Y is the crowning quantity, X is the transverse distance from the centre of the contact surface of the contact element outwards, A and B are real numbers and B is greater than 2, (since the crowning profile would be spherical if B was equal to 2). The expression “centre of the contact surface” is intended to mean the point at which a line would bisect the contact surface.

The inventive crowning profile enlarges the contact area between the contact element and the mating part compared to a spherical or a logarithmic crowning profile, which means that a contact element comprising such a crowning profile can withstand greater contact forces. The inventive crowning profile also helps to maintain a more uniform contact pressure distribution over the contact surface of the contact element, it reduces the wear of the contact element and thus increases the working lifetime of both the contact element and its mating part, which results in systems with improved reliability.

According to an embodiment of the invention, B is less than 20. The wider the contact surface of the contact element, the greater the magnitude of B.

According to a further embodiment of the invention the contact element constitutes part of a cam follower, rocker arm, pushrod, roller or needle bearing, or any other component that is subject to contact pressure, a transverse force or misalignment when in use, such as a component arranged to open and/or close a switch.

According to an embodiment of the invention the contact element is arranged to have the inventive crowning profile over the whole of its contact surface or to have a partial crowning only, i.e. it is arranged to have a crowned surface at only one or more portions of its contact surface. For example the contact surface of a contact element could be arranged to have a substantially flat portion at its centre and an inventive crowning profile at its lateral end portions.

An aspect of the present invention also relates to an internal combustion engine comprising a contact element according to any of the embodiments of the invention.

An aspect of the present invention also concerns a method for determining an optimum crowning profile for at least part of the contact surface of a contact element that is arranged to be rotatably mounted and to abut against a mating part so as to come into rolling contact with the mating part. The method comprises the steps of selecting a plurality of different values of A and B, where B is greater than 2 and defining a plurality of crowning profiles by the function Y(X)=AX^{B} using said A and B values. The A and B values may be determined by means of an optimisation, using finite element analysis for example. The method then comprises the step of determining the total or maximum contact pressure on contact elements having each of said crowning profiles for a given contact force and selecting the crowning profile that would subject a contact element to the lowest total or maximum contact pressure when in use. For spherical crowning profiles the contact pressure and area may for example be calculated using Hertz's theory which yields stresses, deformations and the shape of the interface formed at two contacting bodies. Hertzian stress is a formula which incorporates normal force with factors such as actual contact surface area, mating component geometries and the modulus of elasticity of surface finishes. Hertz's theory can not be used to calculate an accurate contact pressure and area for contact elements having the Inventive crowning profile because such contact elements do not have a constant radius of curvature. Hertz' theory can however be used to provide an approximate contact pressure and area for contact elements having the inventive crowning profile. For a more accurate calculation finite element analysis should be used.

According to an embodiment of the invention, rather than determining the total or maximum contact pressure on a contact element for a given contact force, a parameter indicative of said total or maximum pressure is determined instead. For example since the contact pressure at a point on a contact surface depends on the radius of curvature of the crowning profile at that point (whereby the larger the radius of curvature at a point, the lower the contact pressure) a parameter such as the sum of the radii of curvature for a plurality of points on each crowning profile could be determined in order to select the crowning profile that would subject a contact element to the lowest total or maximum contact pressure when in use. According to an embodiment of the invention, B is a real number less than or equal to 20.

According to a further embodiment of the invention the magnitude of A values is determined using the chosen B values and the maximum crowning quantity gradient Yₘₐₓ′, i.e. the derivative of the crowning profile at the maximum crowning quantity, Yₘₐₓ by putting chosen B values and a Yₘₐₓ′ value into the formula Yₘₐₓ′=ABXₘₐₓ^{B-1} where Xₘₐₓ is half of the width of the contact surface of a contact element, and calculating A values therefrom. According to another embodiment of the invention Yₘₐₓ′ is set equal to the maximum allowed range of variation permitted in maintaining specified dimensions on manufacturing and/or assembling a contact element and/or its mating part, i.e. the sum of the various standard deviations of constituent parts of the contact element and mating part arrangement which affect the alignment of the contact element and/or the mating part.

It is however unlikely that each component affecting the position of a contact element and/or a mating part will be manufactured and/or assembled in such a way that it is just within the maximum allowable tolerance. The variation from specified dimensions should therefore be less than the sum of the allowed ranges of variation of each component in practice. Accordingly, in another embodiment of the invention Yₘₐₓ′ is set equal to the probable range of variation in maintaining specified dimensions on manufacturing and/or assembling a contact element and/or its mating part. According to a further embodiment of the invention said maximum or probable range of variation permitted in maintaining specified dimensions on manufacturing and/or assembling a contact element and/or its mating part is determined empirically, by consulting manufacturers' catalogues for example.

Once an optimum crowning profile for a particular application has been determined a contact element having that optimum crowning profile may be manufactured. The contact element is thereby provided with a smooth contact surface that compensates for any amount of misalignment or a predetermined allowable amount of misalignment of the contact element and its mating part. The inventive crowning profile consequently prevents excessive edge loading that occurs due to such misalignment since it has been adapted to a given geometry taking either all, or most of the possible inclined positions of the contact element and mating part into account. The custom-made crowning profile is therefore insensitive or less sensitive to manufacturing and/or assembling tolerances depending on whether Yₘₐₓ′ is set equal to the maximum or probable range of variation in maintaining specified dimensions on manufacturing and/or assembling a contact element and/or its mating part. In other words even if the contact element having the inventive profile becomes misaligned with its mating part prior to or during its use due to manufacturing and/or assembling imperfections, increases in the contact pressure will be suppressed and damage to the contact surfaces of the contact element and mating part will be prevented, thus maintaining the performance of a system, such as an internal combustion engine, comprising said contact element and mating part.

An aspect of the present invention further concerns a computer program product containing computer program code means arranged to cause a computer or a processor to execute at least one of the steps of a method according to any of the embodiments of the invention stored on a computer-readable medium or a carrier wave.

### BRIEF DESCRIPTION OF THE DRAWINGS

The present invention will hereinafter be further explained by means of non-limiting examples with reference to the appended figures where;

FIG. 1 shows schematically a double rocker arm, such as the one disclosed in WO2004/042215, comprising a contact element according to an embodiment of the present invention,

FIG. 2 illustrates a crowning profile according to an embodiment of the invention,

FIG. 3 is a graph comparing the inventive crowning profile with two crowning profiles according to the prior art, and

FIG. 4 illustrates schematically a contact element according to an embodiment of the invention.

### DETAILED DESCRIPTION

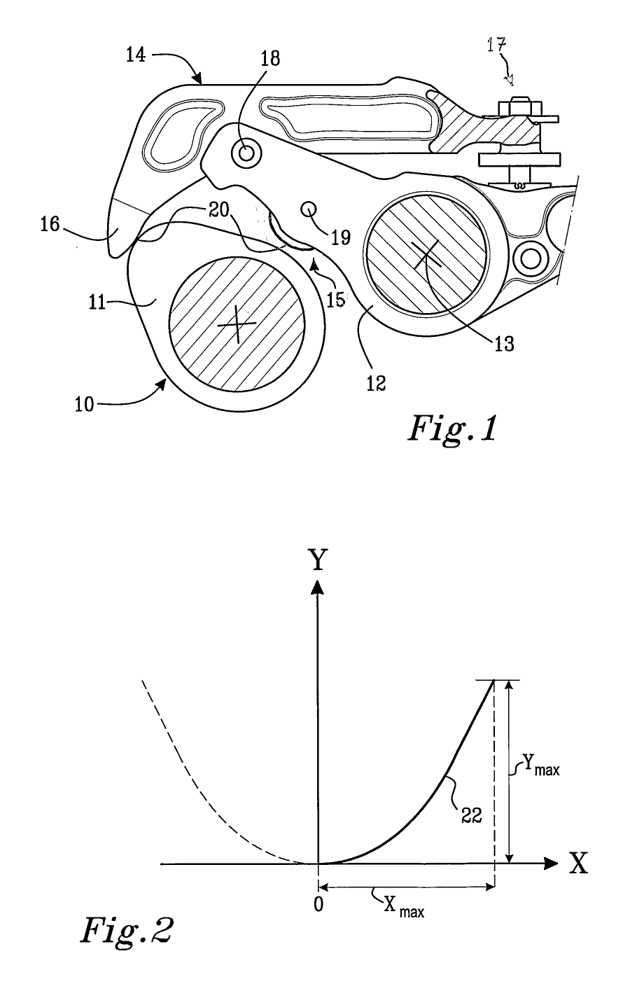

FIG. 1 shows a rocker arm mechanism known from WO 2004/042215, which is actuated by a cam shaft 10 with a cam lobe 11. As the camshaft 10 rotates the cam lobe 11 actuates a rocker arm 12 that is rotatably mounted on a shaft 13. The rocker arm 12 comprises a first cam follower contact element in the form of a rocker arm roller 15 that is rotatably mounted on a shaft 19 and which comprises a crowned contact surface 20 that normally interacts with the cam lobe 11 to operate a valve, such as the intake or exhaust valve of an internal combustion engine, so as to open and close the valve. The rocker arm is also provided with a secondary cam follower in the form of a finger 14 which is rotatably mounted on a shaft 18, i.e. a pivot, and comprises a contact element 16 that has a crowned contact surface 20 that can be made to interact with the cam lobe 11 by movement to an active position (shown in FIG. 1) by means of a hydraulic actuator 17.

The contact element 16 and the roller 15 are designed in accordance with the invention and can be made from, or coated with steel, a ceramic such as silicone nitride or any other suitable material. The crowned contact surfaces 20 of the contact element 16 and the roller 15 minimise contact pressure between the camshaft 10 and the rocker arm 12 as well as between the camshaft 10 and the rocker arm follower 14. This reduces the wear of the contact surfaces of the contact element 16 and the roller 15 and the cam lobe 11 and thus increases the working lifetime of these components. Contact elements having the inventive crowning profile have been found to reduce the contact pressure on the contact surface of the contact element by 30% on parallel contact with a mating part compared to a spherical crowning profile.

In order to ensure good alignment between the contact elements 15, 16 and the cam lobe 11, the rocker arm 12 and rocker arm follower 14 have to be manufactured and assembled to specified dimensions. For example, a first hole has to be drilled perpendicularly to the surface of the rocker arm follower 14 in order to mount the rocker arm follower on a shaft 18 and a second hole has to be drilled perpendicularly to the surface of a rocker arm 12 to mount the rocker arm on a shaft 13 etc. If the allowed standard deviation of each of these holes from its ideal position is σ₁ and σ₂ respectively, Yₘₐₓ′, the maximum crowning gradient, is set equal to the sum of the standard deviation of these holes and of all of the other components whose manufacture and/or assembly affects the alignment of the contact elements 15, 16 and cam lobe 11 i.e. Yₘₐₓ′ is set equal to Σσ₁+σ₂+ . . . etc. Alternatively Yₘₐₓ′ is set equal to the quadratic mean or RMS-value (root mean square) of all of the components whose manufacture and/or assembly affects the alignment of the contact element 16 and cam lobe 11. The RMS-value is determined by calculating the square root of the mean of the squares of the individual standard deviations i.e.

$${Y}_{max}^{′} is set equal to \sqrt{\frac{1}{N} \sum {σ}_{1}^{2} + {σ}_{2}^{2} + …}$$

FIG. 2 shows an inventive crowning profile 22 where X is the distance from the centre, 0, of the contact surface of a contact element 20 (in mm). Y is the crowning quantity (in mm). Xₘₐₓ corresponds to half of width of the contact surface, i.e. Xₘₐₓ defines an end point on the contact surface. The crowning profile 22 is defined by the function Y(X)=AX^{B} where A and B are real numbers and B is greater than 2. A contact element having such a crowning profile might not contact its mating part at its centre point 0 if it is subjected to a transverse force when in use or due to a manufacturing and/or assembling imperfection. The closer the contact area between the contact element and its mating part to the centre point 0 of the contact element, the lower the contact pressure since the radius of curvature of the crowning profile 22 is greatest at the crowning centre point 0.

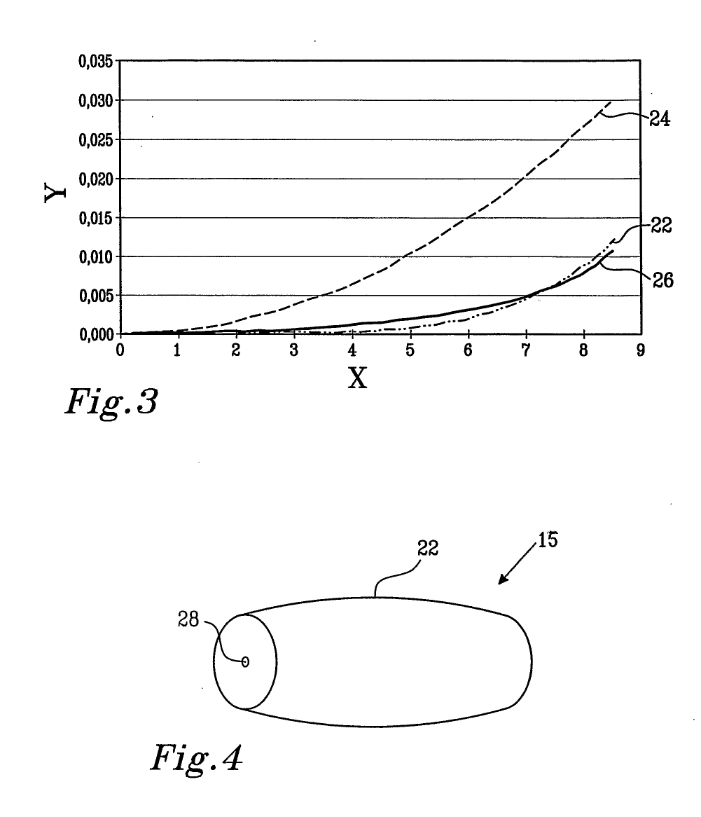

FIG. 3 is a graph showing the inventive crowning profile 22, a spherical crowning profile 24 and a logarithmic crowning profile 26. In the case of the spherical crowning profile 24, the crowning quantity is quite large over most of the contact surface of the contact element and consequently the actual contact area between the contact element and its mating part is quite small. This gives rise to increased contact pressure at the contact area and consequently accelerates the wear of the contact element and its mating part. The logarithmic crowning profile 26 alleviates this problem but is sensitive to manufacturing and/or assembling tolerances. The inventive crowning profile 22 has a much flatter central portion compared to the known crowning profiles, which reduces the contact pressure on the central portion of the contact surface. The inventive crowning profile gradually reduces contact pressure at the two end portions of the contact surface and is less sensitive to manufacturing and assembling tolerances since the crowning profile 22 is determined taking manufacturing and assembling tolerances into account.

FIG. 4 depicts schematically the rocker arm roller 15 comprising a hole 28 for the shaft 19. The contact surface of the roller 15 has a crowning profile 22 defined by the function Y(X)=AX^{B}.

### EXAMPLE

In order to calculate the optimum crowning profile 22 for a contact element 16 having a contact surface of width 2Xₘₐₓ a plurality of values B from 2-20 is chosen. The maximum allowed range of variation permitted in maintaining specified dimensions on manufacturing and/or assembling a contact element, Yₘₐₓ′ is determined and the following formula is used to determine an A value corresponding to each B value.

Yₘₐₓ′=ABXₘₐₓ^{B-1}

Crowning profiles for each set of A and B values can then be defined using the function:

Y=AX^{B}

The total or maximum contact pressure generated on contact surfaces having such crowning profiles is then approximated using Hertz's theory or calculated using finite element analysis.

The crowning profile resulting in the lowest total or maximum contact pressure being generated on the contact surface of a contact element that is intended for a particular application is then chosen as the optimum crowning profile for that contact element.

Further modifications of the invention within the scope of the claims would be apparent to a skilled person. It should be noted that a contact element can comprise a plurality of contact surfaces, whereby each of the contacting surfaces is arranged to contact a corresponding mating surface or mating part.

1. A contact element that is arranged to follow against a mating part comprises a contact surface having a crowning profile on at least a part thereof, wherein the crowning profile is defined by a function Y(X)=AX^{B} where Y is a crowning quantity, X is a distance from a center of the contact surface of the contact element, and wherein A and B are real numbers and B is greater than 2.

2. A contact element according to claim 1, wherein B is less than or equal to 20.

3. A contact element according to claim 1, wherein the contact element comprises part of a component subject to contact pressure when in use.

4. A contact element according to claim 1, wherein the crowning profile is disposed at a lateral end portion of the contact surface.

5. An internal combustion engine comprising a contact element according to claim 1.

6. A method for determining a crowning profile for at least part of a contact surface of a contact element that is to be arranged to be rotatably mounted and to abut against a mating part so as to come into rolling contact with the mating part, comprising:
a) selecting a plurality of different values of A and B, where B is greater than 2,
b) defining a plurality of crowning profiles using a function Y(X)=AX^{B} using the A and B values,
c) determining a total or maximum contact pressure on a contact element having each of the crowning profiles for a given contact force, and
d) selecting the crowning profile that would subject the contact element to one of a lowest total or maximum contact pressure.

7. A method according to claim 6, wherein B is a less than or equal to 20.

8. A method according to claim 6, wherein method step a) comprises:
selecting a plurality of values B and
determining a value A for each value B using the formula Yₘₐₓ′=ABXₘₐₓ^{B-1} where Xₘₐₓ is half of a width of the contact surface of a contact element and Yₘₐₓ′ is a maximum crowning gradient.

9. A method according to claim 8, wherein Yₘₐₓ′ is set equal to a maximum allowed range of variation permitted in maintaining specified dimensions for at least one of manufacturing and assembling a contact element.

10. A method according to claim 8, wherein Yₘₐₓ′ is set equal to a probable range of variation in maintaining specified dimensions for at least one of manufacturing and assembling a contact element.

11. Computer program product, comprising a computer program containing computer program code means arranged to cause a computer or a processor to execute the method according to claim 6, stored on a computer-readable medium.
